(19) United States
(12) Patent Application Publication
(10) Pub. No.: US 2016/0333902 A1
(43) Pub. Date: Nov. 17, 2016

(54) HYDRAULIC CYLINDER DISPLACEMENT MEASUREMENT SYSTEM

(71) Applicant: CATERPILLAR INC., PEORIA, IL (US)

(72) Inventor: Benjamin J. HODEL, Dunlap, IL (US)

(73) Assignee: CATERPILLAR INC., PEORIA, IL (US)

(21) Appl. No.: 14/709,757

(22) Filed: May 12, 2015

(51) Int. Cl. F15B 15/28; F15B 15/08; F15B 19/00

(52) U.S. Cl. CPC F15B 15/2838; F15B 19/00; F15B 15/08; F15B 15/2815

(57) ABSTRACT

A system for measuring hydraulic cylinder displacement may include a sensor configured to generate a signal indicative of a hydraulic fluid flow velocity into or out of the hydraulic cylinder. The system may further include a hydraulic fluid flow model configured to scale the hydraulic fluid flow velocity to a predicted rate of change of cylinder displacement for the hydraulic cylinder. The system may also include a Kalman filter configured to integrate the predicted rate of change of cylinder displacement during a predict phase in order to determine a series of predicted cylinder displacement values over time during operation of the hydraulic cylinder, periodically receive values of cylinder displacement measured optically during operation of the cylinder, periodically update the predicted cylinder displacement values using the optically measured cylinder displacement values during an update phase, fuse the optically measured cylinder displacement values with the predicted cylinder displacement values over time, and output an estimated time series of cylinder displacement values based on the fused values during operation of the hydraulic cylinder.

### TECHNICAL FIELD

The present disclosure relates generally to a system for determining displacement of a hydraulic cylinder and, more particularly, improved accuracy in determination of hydraulic cylinder displacement.

### BACKGROUND

Machines such as haul trucks, dozers, motor graders, wheel loaders, and other types of heavy equipment are used to perform a variety of tasks. Many of these machines use hydraulic actuators to move various components of the machines. The components may include, for example, a boom, a stick, a bucket, a blade, a shovel, a drill, an impact tool, or any other member of the machine. These machines can be manually controlled, autonomously controlled, semi-autonomously controlled, or remotely controlled. In any of these situations, control of the machines may be dependent on positional data provided by different sensors mounted onboard the machines. Positional data may include data that is indicative of the amount of hydraulic cylinder displacement for each of the hydraulic actuators connected to the various components or members of the machine. Hydraulic cylinder displacement is the amount by which a distal end of a piston rod of the hydraulic actuator has either extended from the hydraulic cylinder or retracted into the cylinder from a fixed reference point. The proximal end of the piston rod is connected to a piston that slides within the inner bore of the hydraulic cylinder as hydraulic fluid is forced into either a head end of the cylinder on one side of the piston or a rod end of the cylinder on the opposite, piston rod side of the piston. The piston rod extends from the cylinder as pressurized hydraulic fluid enters the head end of the cylinder and exits the rod end of the cylinder. The piston rod retracts into the cylinder as pressurized hydraulic fluid enters the rod end of the cylinder and exits the head end of the cylinder.

Control of the machines based upon this positional data requires the information provided by the sensors to be accurate at all times. And even though most machine sensor systems are calibrated when first commissioned, vibrations, collisions, interference, range issues, damage, environmental contamination, and normal wear and tear on the machine during operation can reduce the quality of information provided by the sensors.

An exemplary system for determining the position of a piston within a hydraulic cylinder is disclosed in U.S. Pat. No. 6,817,252 (“the '252 patent”) of Wiklund et al. that issued on Nov. 16, 2004. The system of the '252 patent discloses a measuring device that determines the position of the piston as a function of a hydraulic fluid flow. The measuring device includes a bi-directional flow sensor positioned inline with the hydraulic fluid flow and a piston position module. The flow sensor is configured to produce a flow rate signal that is indicative of the flow rate of the hydraulic fluid flow into or out of cavities on the head end side or the rod end side of the piston in the hydraulic cylinder. A piston position module is configured to receive the flow rate signal from the flow sensor and produce a piston position signal that is indicative of the position of the piston within the hydraulic actuator as a function of the flow rate signal.

Although the system of the '252 patent may be useful in determining the displacement of a hydraulic cylinder, there is still room for improvement. In particular, the system of the '252 patent may be subject to errors caused by damage to the flow sensor that measures the hydraulic fluid flow rate. The hardware necessary to measure the hydraulic fluid flow rate into and out of the cylinder is also expensive. Moreover, the flow sensor may introduce undesirable effects on the operation of the hydraulic cylinder since it measures flow rate by introducing a discontinuity within the hydraulic fluid flow and measuring a pressure drop across the discontinuity.

The systems and methods of the present disclosure are directed toward solving one or more of the problems set forth above and/or other problems of the prior art.

### SUMMARY

In one aspect, the present disclosure is directed to a hydraulic cylinder displacement measuring system. The system may include a sensor configured to generate a signal indicative of a hydraulic fluid flow velocity into or out of the hydraulic cylinder, and a hydraulic fluid flow model configured to scale the hydraulic fluid flow velocity to a predicted rate of change of cylinder displacement for the hydraulic cylinder. The system may further include a Kalman filter configured to integrate the predicted rate of change of cylinder displacement during a predict phase in order to determine a series of predicted cylinder displacement values over time during operation of the hydraulic cylinder. The Kalman filter may be further configured to periodically receive values of cylinder displacement measured optically during operation of the cylinder, and to periodically update the predicted cylinder displacement values using the optically measured cylinder displacement values during an update phase. The Kalman filter may be still further configured to fuse the optically measured cylinder displacement values with the predicted cylinder displacement values over time, and output an estimated time series of cylinder displacement values based on the fused values during operation of the hydraulic cylinder.

In another aspect, the present disclosure is directed to a method of determining a hydraulic cylinder displacement. The method may include generating a signal indicative of a hydraulic fluid flow velocity into or out of the hydraulic cylinder, and mapping the hydraulic fluid flow velocity to a predicted rate of change of cylinder displacement for the hydraulic cylinder. The method may further include integrating the predicted rate of change of cylinder displacement during a predict phase of a Kalman filter in order to determine a series of predicted cylinder displacement values over time during operation of the hydraulic cylinder, periodically receiving values of cylinder displacement measured optically during operation of the cylinder, periodically updating the predicted cylinder displacement values using the optically measured cylinder displacement values during an update phase of the Kalman filter, fusing the optically measured cylinder displacement values with the predicted cylinder displacement values over time, and outputting an estimated time series of cylinder displacement values based on the fused values during operation of the hydraulic cylinder.

In yet another aspect, the present disclosure is directed to a non-transitory computer-readable medium including instructions, that, when executed by one or more processors, cause the one or more processors to perform a method of determining a hydraulic cylinder displacement. The method may include generating a signal indicative of a hydraulic fluid flow velocity into or out of the hydraulic cylinder, and mapping the hydraulic fluid flow velocity to a predicted rate of change of cylinder displacement for the hydraulic cylinder. The method may further include integrating the predicted rate of change of cylinder displacement during a predict phase of a Kalman filter in order to determine a series of predicted cylinder displacement values over time during operation of the hydraulic cylinder, periodically receiving values of cylinder displacement measured optically during operation of the cylinder, periodically updating the predicted cylinder displacement values using the optically measured cylinder displacement values during an update phase of the Kalman filter, fusing the optically measured cylinder displacement values with the predicted cylinder displacement values over time, and outputting an estimated time series of cylinder displacement values based on the fused values during operation of the hydraulic cylinder.

### BRIEF DESCRIPTION OF THE DRAWINGS

FIG. 1 is a diagrammatic illustration of an exemplary system configured for accurately determining hydraulic cylinder displacement;

FIG. 2 is a diagram illustrating one possible configuration of the system of FIG. 1;

FIG. 3 illustrates a simplified representation of some of the processes performed by the system of FIG. 1; and

FIG. 4 is a flow chart of a method that may be implemented by the system of FIG. 1.

### DETAILED DESCRIPTION

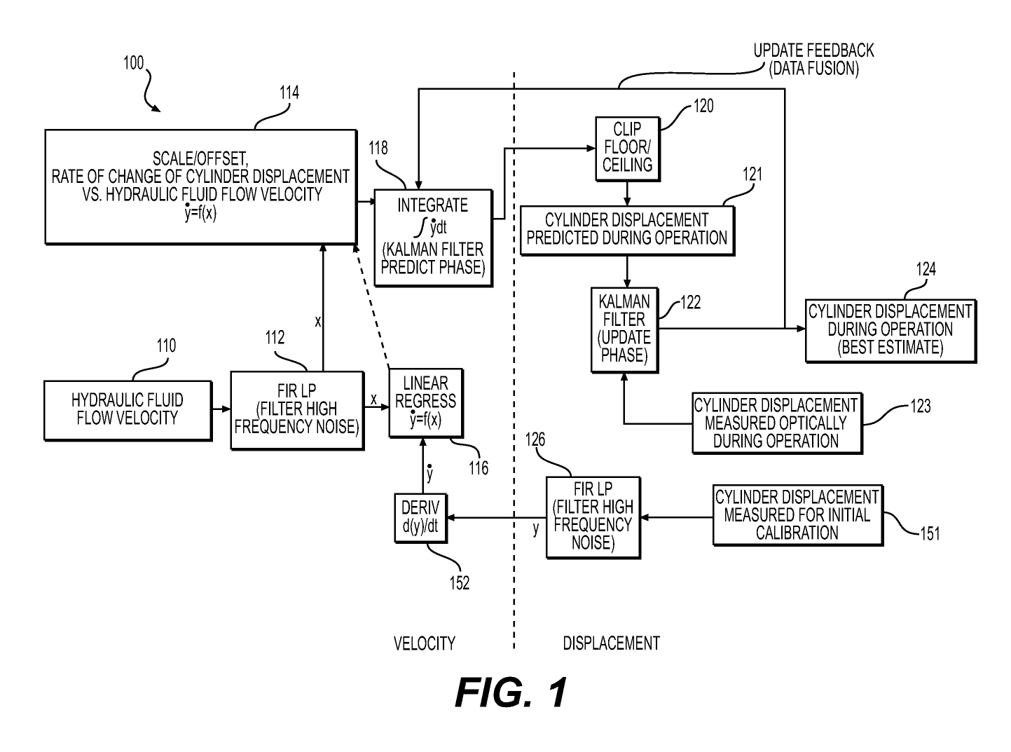

FIG. 1 illustrates a system 100 configured for improving accuracy in the determination of hydraulic cylinder displacement in a hydraulic actuator. The system 100 may be used in conjunction with any one or more of the hydraulic actuators used on a machine performing a task at a worksite. Worksites where the machine operates may include, for example, a mine site, a landfill, a quarry, a construction site, or any other type of worksite. The task being performed by the machine may be associated with altering the geography at the worksite, and may include a hauling operation, a grading operation, a leveling operation, a plowing operation, a bulk material removal operation, or any other type of operation.

The system 100 may comprise one or more processors, processing modules, software subroutines, hardware, circuits, sensors, firmware, and/or various combinations of these and other components and devices configured to provide accurate indications of the hydraulic cylinder displacement for one or more hydraulic actuators while they are in use. Throughout the description that follows, reference to various “modules” will be understood to encompass any of the various components and devices referenced above. For example, a module may embody one or more processors programmed with one or more software subroutines or subprograms in order to perform the desired function encompassed by the module. The various modules may be combined together in various ways, or provided separately. The processor(s) may include any known processing device(s), such as a microprocessor from the Pentium™ or Xeon™ family manufactured by Intel™ the Turion™ family manufactured by AMD™, or any other type of processor. In various alternative embodiments, the modules may be encompassed on one or more Application Specific Integrated Circuits (ASIC), or on Field-Programmable Gate Arrays (FPGA) designed to be configured by a customer or a designer after the FPGA is manufactured. Memory may be provided in conjunction with the modules, and may include one or more storage devices configured to store information used by each processing module to perform certain functions related to disclosed embodiments. The storage devices may include volatile or non-volatile, magnetic, semiconductor, tape, optical, removable, non-removable, or another type of non-transitory computer-readable medium. The storage devices may store programs, subroutines, and/or other information, such as information related to processing data received from one or more sensors.

The hydraulic actuators may include actuators configured to move various components of a mobile machine relative to each other, or actuators associated with other machinery or equipment. Mobile machines that use hydraulic actuators may include, for example, a haul truck, a dozer, a motor grader, or a loader. A mobile machine may be a manned machine configured to traverse a worksite under the control of an operator, a self-directed machine configured to autonomously traverse the worksite, or a hybrid machine configured to perform some functions autonomously and other functions under the control of a local or remote operator. One of ordinary skill in the art will recognize that the same principles and implementations disclosed herein for accurate measurement of hydraulic cylinder displacement may also be applied on stationary equipment having hydraulic actuators used to move various components or members of the machine while the machine remains in a fixed position. The machine may include an engine or other power source functional to provide a power output for various operations of the machine. The power produced by the engine may be directed to various electrical and mechanical systems of the machine such as, for example, a transmission for transmitting the power to one or more traction devices, to a hydraulic system for driving one or more of the hydraulic actuators mounted on the machine, to an implement system for actuating one or more work tools, or to any other electrical or mechanical system configured to perform an operation associated with the machine.

As shown in FIG. 1, the system 100 may include a module 110 configured for determining hydraulic fluid flow velocity into or out of a hydraulic cylinder of a hydraulic actuator (not shown). One or more flow sensors (not shown) may be provided in conjunction with and communicatively coupled to the module 110. A hydraulic actuator generally includes a hydraulic cylinder with a piston slidably contained within the hydraulic cylinder. The piston is attached to a piston rod, which extends from a first axial end of the cylinder on a rod end side of the piston. A rod end cavity is defined within the cylinder on the rod end side of the piston, and a head end cavity is defined within the cylinder between the opposite, head end side of the piston and the second axial end of the cylinder. Hydraulic fluid flows into and out of the rod end and head end cavities through ports in the hydraulic cylinder. The position of the piston within the hydraulic cylinder determines how far the piston rod has extended from the first axial end of the cylinder or retracted into the first axial end. Cylinder displacement, as used throughout this application, refers to the amount by which a distal end of the piston rod of the hydraulic actuator has either extended from the hydraulic cylinder or retracted into the cylinder from a fixed reference point. The head end and rod end cavities in the hydraulic cylinder are completely filled with hydraulic fluid, and the position of the piston and piston rod is directly related to the volume of hydraulic fluid contained within each of the cavities at any point in time. The module 110 may be configured to produce a fluid flow velocity signal based on the volumetric flow rate of hydraulic fluid into or out of the cavities divided by the cross sectional flow area of the cavity into which or out of which the fluid is flowing. The output of module 110 is an actual measured and/or calculated linear velocity of the hydraulic fluid flow entering or exiting from either the head end cavity or rod end cavity of the hydraulic cylinder.

A number of different factors including temperatures, viscosities of the hydraulic fluid, impurities in the fluid, and movement of the hydraulic actuator can affect the measurement of hydraulic fluid flow velocity by introducing high frequency noise or fluctuations in the output from module 110. Therefore, the system 100 may include a module 112 configured to receive the flow velocity signals from the module 110, with the module 112 being configured to filter high frequency noise in the flow velocity signals using, for example, a Finite Impulse Response Low Pass filter (FIR LP). The resulting signal output from the module 112 may be indicative of a smoother, longer term trend in the hydraulic fluid flow velocity x entering and exiting the hydraulic cylinder cavities.

Alternative implementations of this disclosure may include determining the hydraulic fluid flow velocity with module 110 indirectly, rather than by actually measuring fluid flow rates with flow sensors. For example, in applications where an electrical solenoid controls the amount of hydraulic fluid provided to the hydraulic actuator, the module 110 may be configured to produce a signal indicative of the amount of current flowing to the electrical solenoid. This current signal may correlate indirectly through a functional mapping to the hydraulic fluid flow velocity entering and exiting the hydraulic cylinder.

The system 100 may further include modules configured to receive the smoothed output from the module 112, indicative of a longer term trend in the fluid flow velocity x, and scale that smoothed fluid flow velocity x to a predicted rate of change of hydraulic cylinder displacement over time. As shown in FIG. 1, a module 114 may be configured to receive the smoothed fluid flow velocity x and calculate the predicted rate of change of cylinder displacement \dot{y} as a function of the flow velocity x (\dot{y}=f(x)). The accuracy of the predicted rate of change of cylinder displacement determined and output by the module 114 may depend on many different factors including, but not limited to, information on the exact internal physical configuration of a particular hydraulic actuator, characteristics of the hydraulic fluid being used with the actuator, and environmental conditions. Therefore, the system 100 may also include a module 116 configured to modify a flow model used by the module 114 in scaling the hydraulic fluid flow velocity to a predicted rate of change of cylinder displacement. In the exemplary embodiment of FIG. 1, the module 116 may be configured to perform a linear regression analysis in order to provide a best fit between the hydraulic fluid flow velocity and the predicted rate of change of cylinder displacement for the particular hydraulic actuator being monitored during operation.

The linear regression module 116 may be configured to receive data during an initial calibration phase that enables the module 116 to determine the most appropriate analysis and solution for accurately correlating the hydraulic fluid flow velocity to a predicted rate of change of cylinder displacement for a particular hydraulic actuator. In some alternative implementations, the module 116 may determine that a linear regression analysis is not the most appropriate analysis for correlation, and may instead use other algorithms for establishing a best fit model. The exemplary system 100 shown in FIG. 1, may include a module 151 configured for measuring actual cylinder displacement y during an initial calibration phase by, for example, measuring the cylinder displacement y using a device such as a string potentiometer or other displacement transducer while monitoring a carefully controlled and calibrated hydraulic fluid flow velocity into or out of the cylinder. This calibration phase may be performed when a hydraulic actuator is first installed onto a machine and/or at other times under controlled conditions. The system 100 may include another FIR LP module 126 configured to filter high frequency noise that may be obtained during the calibration phase. A calculation module 152 may be configured to receive the measured and smoothed calibration phase cylinder displacement values y, and calculate the rate of change of the cylinder displacement \dot{y} correlating to a particular calibration phase hydraulic fluid flow velocity as the derivative of the cylinder displacement over time (d(y)/dt). The module 116 may be configured to receive the calibration signals indicative of the actual correlation between the rate of change of cylinder displacement and the hydraulic fluid flow into or out of the cylinder, and apply that information in updating and modifying the flow model used by the module 114.

The system 100 may also include a Kalman filter, which is illustrated in the embodiment of FIG. 1 as including a Kalman filter predict phase module 118 and a Kalman filter update phase module 122. The Kalman filter predict phase module 118 may be configured to receive the predicted rate of change of cylinder displacement \dot{y} from the flow model used by the module 114, and integrate the predicted rate of change of cylinder displacement \dot{y} over time (∫ \dot{y} dt) to arrive at a series of predicted values for the hydraulic cylinder displacement over time. A Kalman filter, as is known in the art, may be configured to perform a mathematical method that may be used to determine accurate values of measurements observed over time, such as measurements taken in a time series. The Kalman filter uses a system's dynamics model derived from physics-based calculations, such as the flow model used by module 114, and multiple sequential measurements (such as from sensors) to form an estimate of a system's varying quantities (the state of the system). The Kalman filter fuses or combines the model-derived data and the sensor-derived data to arrive at a better estimate of the actual cylinder displacement over time than could be obtained by using any one measurement alone. As a result, the Kalman filter helps to correct for drift in the series of predicted values for hydraulic cylinder displacement over time that would result from errors in measured hydraulic fluid flow velocities and integration errors.

The system 100 may further include a clipping module such as clip floor/ceiling module 120 configured to receive the time series of predicted values for hydraulic cylinder displacement resulting from the integration performed by the Kalman filter predict phase module 118. The clip floor/ceiling module 120 may be configured to set boundaries on the values of predicted cylinder displacement that are designed to keep the predicted values within the realm of believability. For example, the clip floor/ceiling module 120 may be configured to recognize that a value for actual cylinder displacement cannot go beyond an amount corresponding to the piston of the hydraulic actuator reaching a stop at the head end or the rod end of the hydraulic cylinder. The system 100 may include another module 121 configured to receive the data that falls within the range established by the clip floor/ceiling module 120. The module 121 may be configured to receive only the realistic values of cylinder displacement that have been predicted by the Kalman filter predict phase module 118 during operation of the hydraulic actuator.

As mentioned above, the Kalman filter's general operation involves two phases, a “predict” phase and a measurement or “update” phase. In the predict phase, the value estimate from the previous timestep in the time series of predicted cylinder displacement values is used to generate an a priori value estimate. In the update phase, the a priori estimate calculated in the predict phase is combined with an estimate of the accuracy (e.g., the variance) of the a priori estimate, and a current measurement value to produce a refined a posteriori estimate. In the exemplary embodiment shown in FIG. 1, the Kalman filter update phase module 122 may be configured to periodically receive cylinder displacement data measured optically during operation of the hydraulic actuator from the module 123. Optical measurement of the cylinder displacement may be performed by various devices or sensors including non-intrusive devices such as Laser Imaging Detection and Ranging (LIDAR) devices, Radio Detection and Ranging (RADAR) devices, infrared devices, stereo cameras, wireless Internet Protocol (IP) cameras, and other image detection devices. The optical measurement devices may be placed on portions of the machine that provide a clear and unobstructed view of the hydraulic cylinder, or off of the machine at various monitoring locations. The actual optically measured cylinder displacement values received from the module 123 may be processed and fused by the Kalman filter update phase module 122 through a feedback loop with the predicted values determined by the Kalman filter predict phase module 118. The Kalman filter update phase module 122 may be configured to weight the actual optically measured values of cylinder displacement from module 123 relative to the predicted values based on a determination of which values have a smaller estimated uncertainty. The output from the Kalman filter update phase module 122 may be provided to a best estimate module 124 configured to output the best estimate of the cylinder displacement based on the fused values during operation of the hydraulic actuator. One of ordinary skill in the art will recognize that although this disclosure discusses optically measured cylinder displacement values, the same disclosed principles may be used in conjunction with other non-intrusive methods of measuring cylinder position, such as methods using proximity sensors, RFID sensors, and other devices.

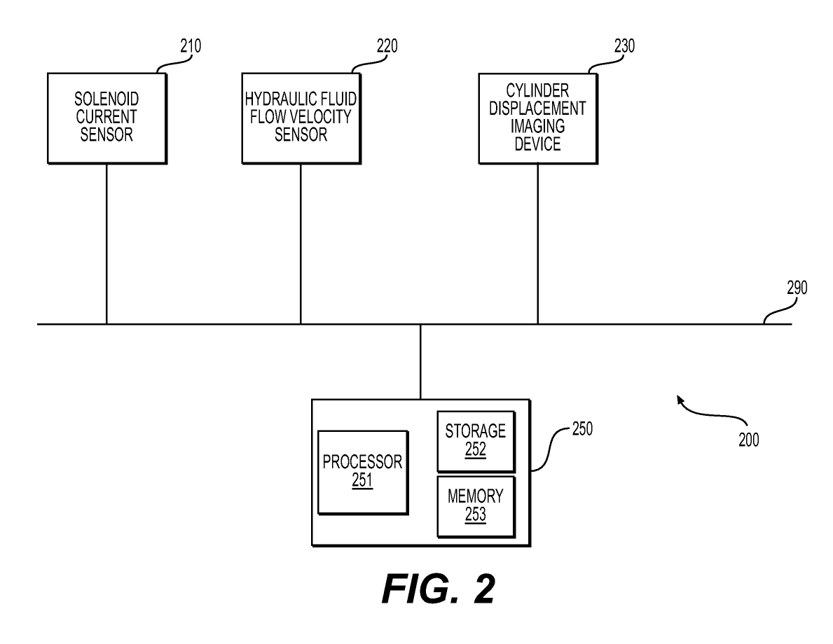

FIG. 2 illustrates one exemplary configuration of a system 200 for accurately determining hydraulic cylinder displacement in accordance with the principles discussed above. In the embodiment of FIG. 2, a solenoid current sensor 210, a hydraulic fluid flow velocity sensor 220, and a cylinder displacement imaging device 230 are all shown as being interconnected with a controller 250 over an electrical bus 290. The controller 250 may include one or more processors or processing modules 251 communicatively coupled with one or more storage devices 252 and memories 253. One of ordinary skill in the art will recognize that the various components illustrated in FIG. 2 may be communicatively coupled in ways other than the bus 290, such as by wireless connections, Ethernet connections, cellular connections, or combinations of wireless and wired connections. Data may also be communicated over various networks, including intranet networks and the Internet, and stored in one or more servers, including remote, Cloud-based servers.

In certain exemplary embodiments, the controller 250 may be configured to include the Kalman filter predict phase module and the Kalman filter update phase module in the one or more processors 251. The Kalman filter modules may utilize the following equations in the calculations performed by each module. For the predict phase module, the Kalman filter may be configured to utilize the following generic equations:

\hat{x}ₖ⁻=Fₖ₋₁\hat{x}ₖ₋₁+Gₖ₋₁uₖ₋₁ (1)

Pₖ⁻=Fₖ₋₁P_{K-1}⁺Fₖ₋₁^{T}+Qₖ₋₁ (2)

For the measurement or “update” phase, the Kalman filter may be configured to utilize the following generic equations:

Kₖ=Pₖ₋₁⁻H^{T}(HₖPₖ₋₁⁻Hₖ^{T}+Rₖ)⁻¹ (3)

\hat{x}ₖ⁺=\hat{x}ₖ⁻+Kₖ(yₖ−Hₖ\hat{x}ₖ⁻) (4)

Pₖ⁺=(I−KₖHₖ)Pₖ⁻ (5)

In the above equations, \hat{x}ₖ⁻ may be the a priori state estimate of the predicted hydraulic cylinder displacement that is calculated based on the a posteriori state estimate (\hat{x}ₖ₋₁) from an immediately preceding time step. The Kalman filter predict phase module 118 discussed above may be configured to calculate the time series of predicted hydraulic cylinder displacement values by integrating the rate of change of cylinder displacement over time. F, G, and H may be appropriate state transition matrices.

In the measurement or “update” phase, the Kalman filter may calculate the Kalman gain Kₖ utilizing equation (3), in which P is an error covariance matrix and R is a matrix setting forth the variance associated with the different state variables. For example, the values in the R matrix may specify the uncertainty associated with the measurement of hydraulic fluid flow velocity. In the measurement or update phase, the Kalman filter may also obtain an independent measure of the hydraulic cylinder displacement, such as by optically measuring the cylinder displacement, and set the independent measurement as yₖ. Utilizing the a priori estimate \hat{x}ₖ⁻ from the “predict” phase, the updated measurement yₖ, and the Kalman gain Kₖ, the controller 250 may calculate the a posteriori state estimate \hat{x}ₖ⁺ utilizing equation (4). The result output by the Kalman filter is the best estimate of the hydraulic cylinder displacement values during operation of the hydraulic actuator.

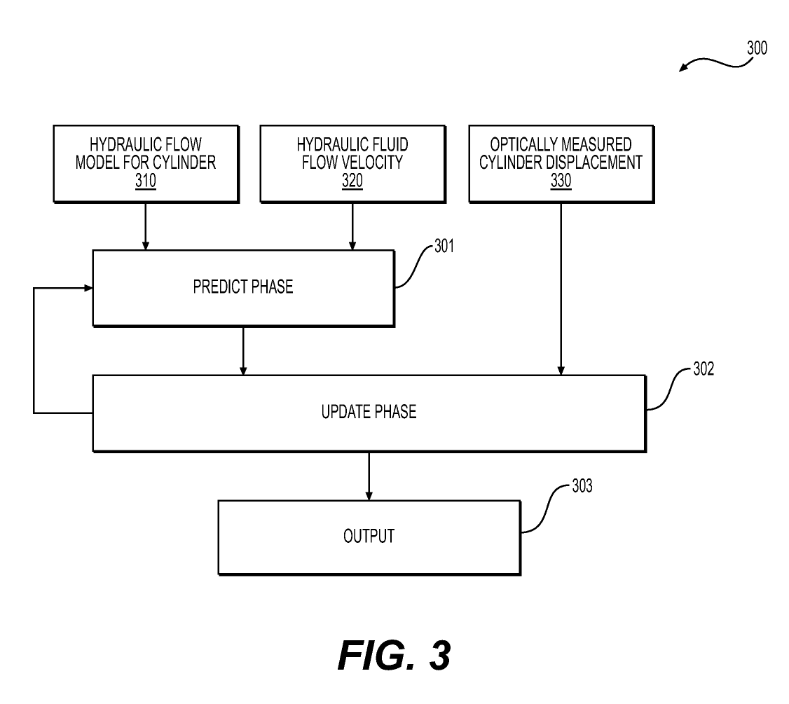

FIG. 3 illustrates an exemplary process performed by a Kalman filter 300 during an implementation of the above-described system for accurately determining a hydraulic cylinder displacement. In the predict phase 301 of the Kalman filter 300, the controller 250 (shown in FIG. 2) may utilize the hydraulic fluid flow velocity 320 and the hydraulic flow model 310 for the particular hydraulic cylinder to calculate an a priori state estimate of the predicted cylinder displacement values over time. In the predict phase 301, the controller 250 may cause the Kalman filter 300 to execute equations (1) and (2). For example, in the predict phase, the Kalman filter 300 may calculate \hat{x}ₖ⁻ (a priori state estimate) of the cylinder displacement using a value (\hat{x}^{k-1}) of the cylinder displacement from an immediately preceding time step, inputs from the hydraulic flow model 310 for the particular cylinder, and the hydraulic fluid flow velocity 320.

Following the predict phase 301, the Kalman filter 300 may periodically implement the update phase 302 to calculate the a posteriori state estimate \hat{x}ₖ⁺ utilizing, for example, equation (4). For example, the Kalman filter 300 may calculate the a posteriori state estimate xₖ⁺ using the a priori estimate \hat{x}ₖ⁻ from the predict phase 301, the update measurement yₖ obtained from the optically measured cylinder displacement 330, and the Kalman gain Kₖ. The Kalman filter 300 may receive as input in the update phase 302, the optically measured cylinder displacement 330, and set this input as the update measurement yₖ in equation (4). Because the certainty of the measurements is often difficult to measure precisely, it is common to discuss the filter's behavior in terms of gain. The Kalman gain Kₖ is a function of the relative certainty of the measurements and current state estimate, and can be “tuned” to achieve particular performance. With a high gain, the filter places more weight on the measurements, and thus follows them more closely. With a low gain, the filter follows the model predictions more closely, smoothing out noise but decreasing the responsiveness. At the extremes, a gain of one causes the filter to ignore the state estimate entirely, while a gain of zero causes the measurements to be ignored.

In determining the uncertainty associated with the measurements of hydraulic fluid flow velocity using the Kalman filter 300, the controller 250 may also consider the operation state of the machine on which the hydraulic actuator is mounted. For example, if the machine is older, and is operating in an environment where flow sensors are likely to have experienced a lot of shocks and other harsh conditions, the controller 250 may change certain parameters of the Kalman filter 300, such as the Kalman gain Kₖ, the error covariance matrix P, or the state variable variance matrix R, to reflect the accuracy or confidence in certain input parameters.

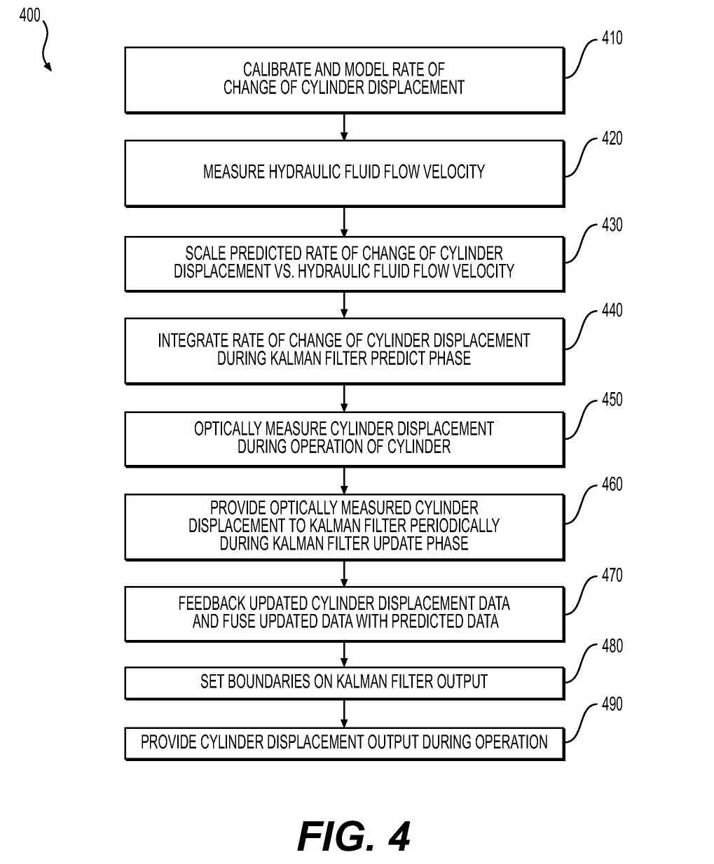

FIG. 4 illustrates an exemplary process 400 implemented by the system of FIG. 1 to predict a hydraulic cylinder displacement, periodically update the predicted displacement using measured values of the displacement, and output a best estimate of the cylinder displacement during operation of a hydraulic actuator. A detailed description of the process 400 shown in FIG. 4 is provided in the following section.

### INDUSTRIAL APPLICABILITY

The disclosed hydraulic cylinder displacement measurement system may be applicable to any machine where accurate detection of the amount of hydraulic cylinder displacement is desired. The disclosed system may provide for improved prediction and measurement of the hydraulic cylinder displacement by utilizing a Kalman filter to fuse predicted cylinder displacement values based on hydraulic fluid flow velocities and optically measured cylinder displacement values. The physics-based calculations used to establish a correlation between a hydraulic fluid flow velocity into or out of the hydraulic cylinder and time series values for predicted cylinder displacement may result in the predicted cylinder displacement values drifting away from the true values of cylinder displacement. This drift may be caused by errors in the flow velocities measured by the flow sensor, changes to the internal configuration of the hydraulic cylinder caused by wear or impurities in the hydraulic fluid, and integration errors introduced during integration of the predicted rate of change of cylinder displacements obtained from a flow model for the hydraulic cylinder. The Kalman filter helps to reduce errors by periodically updating the predicted values of cylinder displacement with measured values that may be obtained, for example, by optical imaging of the hydraulic cylinder during operation. The Kalman filter may average the predictions of cylinder displacement with each new measured value using a weighted average. The purpose of the weighting applied to the predicted and/or measured values is that the values with better (i.e., smaller) estimated uncertainty are “trusted” more. The weights may be calculated from the covariance, which is a measure of the estimated uncertainty of the predictions of the cylinder displacements. The result of the weighted average is a new estimate of cylinder displacement that lies between the predicted and measured values, and has a better estimated uncertainty than either alone. This process may be repeated every time step, with the new estimate and its covariance informing the prediction used in the following iteration. The Kalman filter works recursively and requires only the last best estimate, rather than the entire history of predicted cylinder displacements to calculate a new cylinder displacement.

As shown in FIG. 4, a process 400 in accordance with an exemplary implementation of this disclosure may include calibrating and modeling the rate of change of cylinder displacement (Step: 410). The calibration may include measuring the actual cylinder displacement over time under controlled conditions by using a string potentiometer or other displacement transducer. These calibration phase measurements may be performed for each particular hydraulic actuator, or for each particular model of hydraulic actuator having, for example, the same internal measurements and operating with the same hydraulic fluid under the same conditions. The calibration measurement of cylinder displacements over time taken in conjunction with the hydraulic fluid flow into or out of the cylinder during the calibration phase may be used to establish a flow model for correlating hydraulic fluid flow velocity into or out of the cylinder with a rate of change of cylinder displacement. The flow model may be stored in memory and updated periodically as additional calibrations are performed. The flow model may be in the form of a mapping between hydraulic fluid flow velocities into or out of the hydraulic cylinder and the rate of change of hydraulic cylinder displacement over time. The period of time over which a calibration phase is performed may be varied depending on factors such as the level of certainty for predicted and measured values.

At Step: 420, a flow sensor may be used to measure hydraulic fluid flow velocity into or out of the hydraulic cylinder. In various alternative implementations, the hydraulic fluid flow velocity may be determined indirectly from other correlated measurements, such as the amount of voltage or current being applied to a solenoid that controls the fluid flow into or out of the hydraulic cylinder. The predicted cylinder displacement values may be calculated from the hydraulic fluid flow velocity taken together with other information specific to the particular hydraulic cylinder, such as the internal dimensions of the cylinder, the current temperature, the pressure of the hydraulic fluid, and the viscosity of the hydraulic fluid.

At Step: 430, a model may be used to scale a predicted rate of change of cylinder displacement vs. the hydraulic fluid flow velocity. Information obtained during the calibration and modeling step (Step: 410) may be used to verify the physics-based calculations that correlate the predicted rate of change of cylinder displacement to the hydraulic fluid flow velocity. The model may consist of a mapping between hydraulic fluid flow velocities into or out of a particular hydraulic cylinder and the predicted hydraulic cylinder displacement over time.

At Step: 440, a controller may cause a Kalman filter to integrate the rate of change of cylinder displacement during the Kalman filter predict phase to arrive at a time series of predicted cylinder displacement values. As discussed above, the Kalman filter module of the controller may be configured to fuse the predicted values for cylinder displacement with updated measured values. At Step: 450, the controller may cause imaging devices to periodically optically measure cylinder displacement during operation of the cylinder using various imaging techniques discussed above, such as LIDAR and RADAR. At Step: 460, the controller may receive input from the imaging devices and periodically provide the optically measured cylinder displacement values to the Kalman filter during the Kalman filter update phase.

At Step: 470, the controller may cause feedback of the updated cylinder displacement data and fusing of the updated data with the predicted data that was determined during the Kalman filter predict phase. As discussed above, the Kalman filter may average the predicted cylinder displacement values with the updated cylinder displacement values using a weighted average. In some implementations, for example, the estimated uncertainty associated with hydraulic fluid flow velocities may be high as a result of environmental conditions, the age of the flow sensors, or the quality of the hydraulic fluid. In this situation, the Kalman filter may give more weight to the optically measured cylinder displacement values. However, in other situations where the conditions during operation make it difficult for an optical imaging device to obtain an accurate indication of cylinder displacement, the Kalman filter may give more weight to the predicted cylinder displacement values based on hydraulic fluid flow velocities into or out of the cylinder.

At Step: 480, the controller may set boundaries on the Kalman filter output in order to maintain the estimates of cylinder displacement within the realm of believability. A clip floor/ceiling module may set the boundaries based on specific information for a particular hydraulic actuator, such as the physical limits for extension or retraction of the piston rod based on known stops within the hydraulic cylinder, or other physical limits on movement of the hydraulic actuator imposed by the configuration of the machine on which the hydraulic actuator is mounted. At Step: 490, the output from the fusion of updated measured values of cylinder displacement over time and predicted values for the cylinder displacement provide a best estimate of cylinder displacement output during operation of the hydraulic actuator.

It will be apparent to those skilled in the art that various modifications and variations can be made to the disclosed system and method for improved accuracy in determination of hydraulic cylinder displacement. Other embodiments will be apparent to those skilled in the art from consideration of the specification and practice of the disclosed system. It is intended that the specification and examples be considered as exemplary only, with a true scope being indicated by the following claims and their equivalents.

What is claimed is:

1. A hydraulic cylinder displacement measuring system, comprising:
a sensor configured to generate a signal indicative of a hydraulic fluid flow velocity into or out of the hydraulic cylinder;
a hydraulic fluid flow model configured to scale the hydraulic fluid flow velocity to a predicted rate of change of cylinder displacement for the hydraulic cylinder; and
a Kalman filter configured to:
integrate the predicted rate of change of cylinder displacement during a predict phase in order to determine a series of predicted cylinder displacement values over time during operation of the hydraulic cylinder;
periodically receive values of cylinder displacement measured optically during operation of the cylinder;
periodically update the predicted cylinder displacement values using the optically measured cylinder displacement values during an update phase;
fuse the optically measured cylinder displacement values with the predicted cylinder displacement values over time; and
output an estimated time series of cylinder displacement values based on the fused values during operation of the hydraulic cylinder.

2. The system of claim 1, wherein the Kalman filter is further configured to estimate an uncertainty of one or more of the predicted cylinder displacement values in order to calculate a weight to give to the one or more predicted cylinder displacement values before fusing with the optically measured cylinder displacement values.

3. The system of claim 1, wherein the Kalman filter is further configured to estimate an uncertainty of one or more of the optically measured cylinder displacement values in order to calculate a weight to give to the one or more optically measured cylinder displacement values before fusing with the predicted cylinder displacement values.

4. The system of claim 1, further including a finite impulse response low pass filter (FIR LP) configured to filter high frequency noise in the signal indicative of a hydraulic fluid flow velocity.

5. The system of claim 1, further including a calibration module configured to measure cylinder displacement values during a calibration phase and correlate the measured calibration phase cylinder displacement values over time to measured calibration phase hydraulic fluid flow velocities into or out of the cylinder.

6. The system of claim 5, further including a calculation module configured to calculate a calibration rate of change of the calibration phase cylinder displacement values.

7. The system of claim 6, wherein the hydraulic fluid flow model is at least partially based upon a linear regression analysis of the calibration rate of change of the calibration phase cylinder displacement values as a function of the calibration phase hydraulic fluid flow velocities.

8. The system of claim 1, wherein the hydraulic fluid flow model is derived at least partially from physics-based calculations defining the relationship between hydraulic fluid flow velocity into or out of the hydraulic cylinder and the predicted rate of change of cylinder displacement.

9. The system of claim 1, further including a clipping module configured to set at least one of an upper limit and a lower limit beyond which the predicted cylinder displacement values are not used.

10. A method of determining a hydraulic cylinder displacement, the method comprising:
generating a signal indicative of a hydraulic fluid flow velocity into or out of the hydraulic cylinder;
mapping the hydraulic fluid flow velocity to a predicted rate of change of cylinder displacement for the hydraulic cylinder;
integrating the predicted rate of change of cylinder displacement during a predict phase of a Kalman filter in order to determine a series of predicted cylinder displacement values over time during operation of the hydraulic cylinder;
periodically receiving values of cylinder displacement measured optically during operation of the cylinder;
periodically updating the predicted cylinder displacement values using the optically measured cylinder displacement values during an update phase of the Kalman filter;
fusing the optically measured cylinder displacement values with the predicted cylinder displacement values over time; and
outputting an estimated time series of cylinder displacement values based on the fused values during operation of the hydraulic cylinder.

11. The method of claim 10, further including:
estimating an uncertainty of one or more of the predicted cylinder displacement values in order to calculate a weight to give to the one or more predicted cylinder displacement values before fusing with the optically measured cylinder displacement values.

12. The method of claim 10, further including:
estimating an uncertainty of one or more of the optically measured cylinder displacement values in order to calculate a weight to give to the one or more optically measured cylinder displacement values before fusing with the predicted cylinder displacement values.

13. The method of claim 10, further including filtering high frequency noise in the signal indicative of a hydraulic fluid flow velocity.

14. The method of claim 10, further including:
measuring cylinder displacement values during a calibration phase and correlating the measured calibration phase cylinder displacement values over time to measured calibration phase hydraulic fluid flow velocities into or out of the cylinder.

15. The method of claim 14, further including calculating a calibration rate of change of the calibration phase cylinder displacement values.

16. The method of claim 15, wherein mapping the hydraulic fluid flow velocity to a predicted rate of change of cylinder displacement for the hydraulic cylinder is at least partially based upon a linear regression analysis of the calibration rate of change of the calibration phase cylinder displacement values as a function of the calibration phase hydraulic fluid flow velocities.

17. The method of claim 10, wherein mapping the hydraulic fluid flow velocity to a predicted rate of change of cylinder displacement for the hydraulic cylinder includes performing physics-based calculations defining the relationship between hydraulic fluid flow velocity into or out of the hydraulic cylinder and the predicted rate of change of cylinder displacement.

18. The method of claim 10, further including setting at least one of an upper limit and a lower limit beyond which the predicted cylinder displacement values are not used.

19. A non-transitory computer-readable medium including instructions, that, when executed by one or more processors, cause the one or more processors to perform a method of determining a hydraulic cylinder displacement, the method comprising:
generating a signal indicative of a hydraulic fluid flow velocity into or out of the hydraulic cylinder;
mapping the hydraulic fluid flow velocity to a predicted rate of change of cylinder displacement for the hydraulic cylinder;
integrating the predicted rate of change of cylinder displacement during a predict phase of a Kalman filter in order to determine a series of predicted cylinder displacement values over time during operation of the hydraulic cylinder;
periodically receiving values of cylinder displacement measured optically during operation of the cylinder;
periodically updating the predicted cylinder displacement values using the optically measured cylinder displacement values during an update phase of the Kalman filter;
fusing the optically measured cylinder displacement values with the predicted cylinder displacement values over time; and
outputting an estimated time series of cylinder displacement values based on the fused values during operation of the hydraulic cylinder.

20. The non-transitory computer-readable medium of claim 19, further including instructions, that, when executed by the one or more processors, further cause the one or more processors to:
estimate an uncertainty of one or more of the predicted cylinder displacement values in order to calculate a weight to give to the one or more predicted cylinder displacement values before fusing with the optically measured cylinder displacement values; and
estimate an uncertainty of one or more of the optically measured cylinder displacement values in order to calculate a weight to give to the one or more optically measured cylinder displacement values before fusing with the predicted cylinder displacement values.
